(19) United States
(12) Patent Application Publication
(10) Pub. No.: US 2005/0098917 A1
(43) Pub. Date: May 12, 2005

(54) Manufacturing method for an environment protection inner lining (sleeve)

(76) Inventor: Chien-Sen Chiu, Taichung Hsien (TW)

Correspondence Address: Chien-Sen Chiu, P.O. Box No. 6-57, Junghe, Taipei, 235, TW

(21) Appl. No.: 10/701,521

(22) Filed: Nov. 6, 2003

(51) Int. Cl. C08J 3/00

(52) U.S. Cl. 264/140; 264/330

(57) ABSTRACT

The present invention provides a manufacturing method for an environment protection inner lining (sleeve) employing a multi-stage processing method, and utilizing fibrous raw materials as basic material. Upon mixing the fibrous main raw materials, starch and an additive, the mixed raw materials are thermally press molded at a high temperature and high pressure by means of a (high temperature, high pressure) pressure molding machine, thereby forming an environment protection inner lining (sleeve) of a prescribed shape, wherefrom the environment protection inner lining (sleeve) may be adapted to fit inside shoes and clothing, achieving effectiveness of recycling agriculture waste thereof, while accomplishing objective of environment conservation.

### BACKGROUND OF THE INVENTION

(a) Field of the Invention

The present invention relates to a manufacturing method for an environment protection inner lining (sleeve) employing a multi-stage processing method, and more particularly to utilizing fibrous raw materials as basic material.

(b) Description of the Prior Art

According to an inner lining of conventional shoes and clothing, the inner lining is manufactured from paper pulp molded into an inner sleeve or from a plastic inner sleeve. However, during manufacturing process of the paper pulp, sewage of high alkali content is produced, not only easily polluting water sources, and thus a major drawback, but also manufacture of the paper pulp requires felling of trees, and thereby destroying forests, subsequently resulting in adding to green house effect, even affecting ecosystem of natural environment.

Furthermore, the plastic inner sleeve is manufactured as a secondary product of petrochemical industries, and is not only a waste of energy resources, but also, because the plastic inner sleeve is a one-off product, after discarding, degeneration of the plastic is difficult, and results in secondary pollution, and therefore completely inappropriate for environment conservation usage.

Motivation for the present invention emanates from providing a manufacturing method for an environment protection inner lining (sleeve) that is not only convenient to implement, but also of benefit to environment protection.

### SUMMARY OF THE INVENTION

Primary objective of the present invention is to provide a manufacturing method for an environment protection inner lining (sleeve), employing a multi-stage processing method, and utilizing fibrous raw materials as basic materials. Upon mixing the fibrous main raw materials, starch and an additive, the mixed raw materials are thermally press molded at a high temperature and high pressure by means of a (high temperature, high pressure) pressure molding machine, thereby forming an environment protection inner lining (sleeve) of a prescribed shape, wherefrom the environment protection inner lining (sleeve) may be adapted to fit inside shoes and clothing, achieving effectiveness of recycling agriculture waste thereof, while accomplishing objective of environment conservation, as well as thoroughly resolving problems of air pollution resulting from burning agricultural waste, and adding supplementary value to agricultural products, thus making best use of agriculture waste, while increasing income of farmers. Moreover, after usage of the environment protection inner lining (sleeve), the environment protection inner lining (sleeve) may be recycled and once more made use of. If organic fertilizers are produced, the organic fertilizers may be utilized to re-manufacture other commodities. If discarded, the environment protection inner lining (sleeve) will autodecompose, effectively eliminating secondary pollution, and thereby achieving objective of environment conservation.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a system block diagram for manufacturing process of main raw material according to the present invention.

FIG. 2 shows a system block diagram for manufacturing process of an additive according to the present invention.

FIG. 3 shows a system block diagram for manufacturing process of a finished product according to the present invention.

FIG. 4 shows an elevational of one embodiment of an inner lining for a shoe according to the present invention.

FIG. 5 shows an elevational of another embodiment of the inner lining for clothing according to the present invention.

### DETAILED DESCRIPTION OF THE PREFERRED EMBODIMENTS

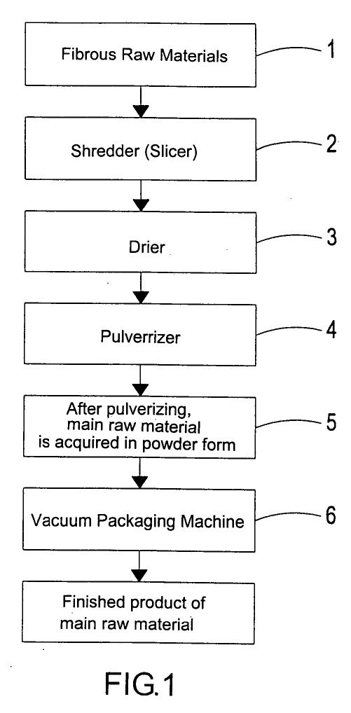

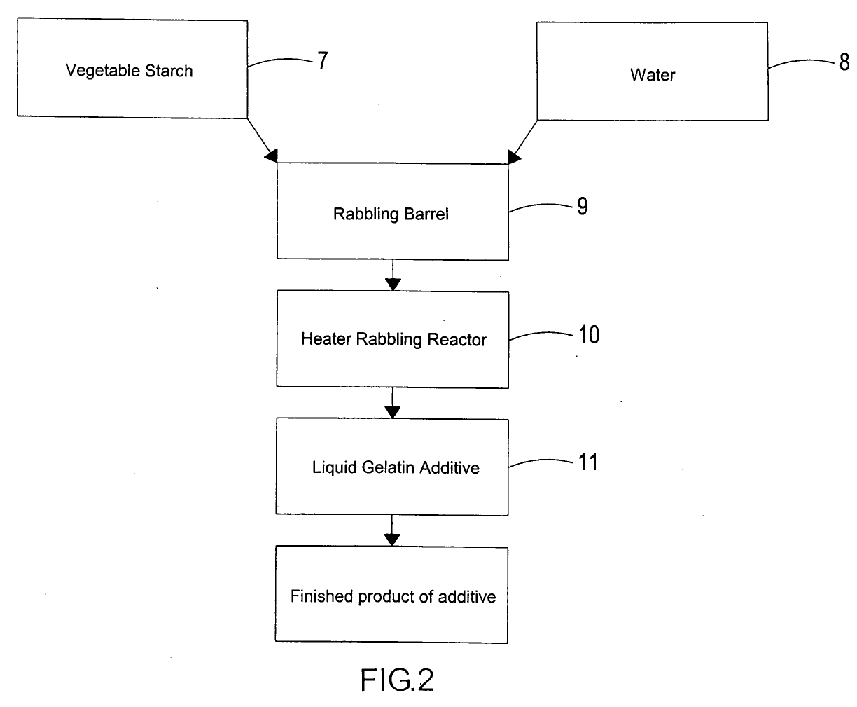

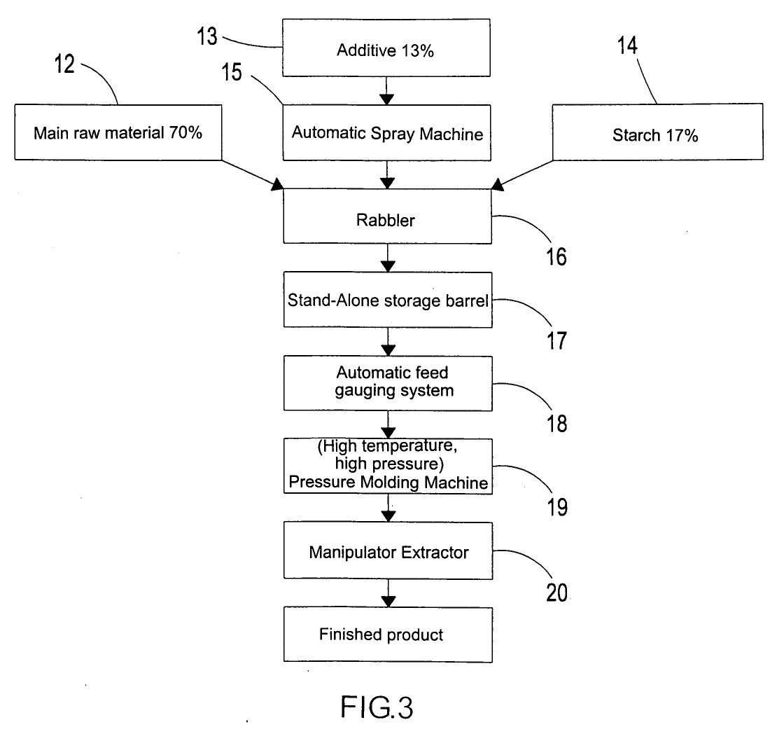

Referring to FIGS. 1, 2 and 3, which show system block diagrams for the present invention employing a multi-stage processing method, and utilizing fibrous raw materials as basic materials, whereby elimination of hazards that result in environment pollution is achieved, and accomplishes environment conservation, as well as attaining effectiveness of reducing wastage of energy resources. The present invention affects an evident function for industry with regard to advancement and environment protection, wherein manufacturing method of the environment protection inner lining (sleeve) is as below:
A, Employ a shredder (slicer) 2 to first shred fibrous raw materials 1 (refer to accompanying FIG. 1) from agricultural waste products, such as rice hulls, wheat hulls, sorghum hulls, peanut shells, bean pods, coconut hulls, rice stems, wheat stems, corn stems, sorghum stems, bean stems, cotton stems, timber, bamboo, etc., thereafter use a drier 3 to dry the fibrous raw materials 1, subsequently, use a pulverizer 4 to pulverize the fibrous raw materials 1. After pulverizing, main raw material is acquired in powder form. Finally employ a vacuum packaging machine 6 to pack the powder, thereby acquiring a finished product of the main raw material 12;
B, next, simultaneously place plant starch 7 and water 8 (refer to accompanying FIG. 2) into a rabbling barrel 9 and rabble, while at the same time heat and rabble the plant starch 7 and water 8 with a heater rabbling reactor 10, forming a thick form of paste therefrom, subsequently, add an additive of liquid gelatin 11, thereby acquiring a finished product of the additive 13;
C, finally add main the raw material 12 (approximately 70% by weight) and starch 14 (approximately 17% by weight) to a rabbler 16 (refer to accompanying FIG. 3), simultaneously spray the additive 13 (approximately 13% by weight) into the rabbler 16 with an automatic spray machine 15 and synchronously stir. After the main raw material 12, the additive 13 and the starch 14 have been thoroughly stirred, store in a stand-alone storage barrel 17, and employ an automatic feed gauging system 18 to feed resulting stirred mixed material into a (high temperature, high pressure) pressure molding machine 19, therefrom the (high temperature, high pressure) pressure molding machine 19 thermally press molds the mixed material into a shape, thereby molding an environment protection inner lining (sleeve) of a prescribed shape. Thereafter, extract the environment protection inner lining (sleeve) by means of a manipulator extractor 20, thus achieving effectiveness of a rapid shape-forming processing method.

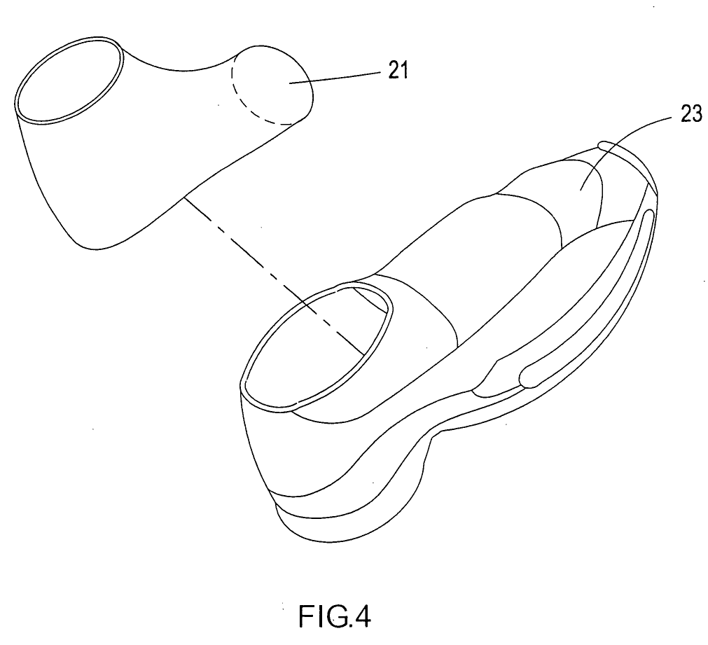

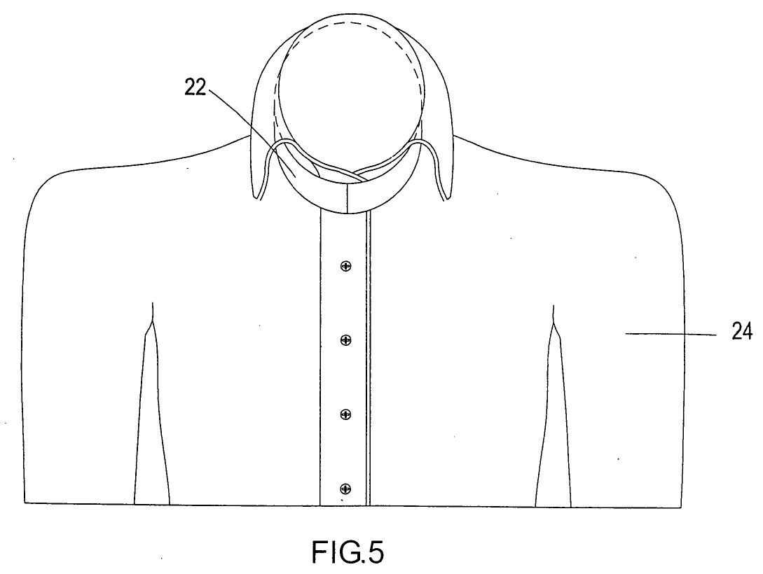

The present invention provides a manufacturing method for an environment protection inner lining (sleeve), wherein upon mixing main raw materials 12 (approximately 70% by weight), starch 14 (approximately 17% by weight) and an additive 13 (approximately 13% by weight), employ an automatic feed gauging system 18 to feed resulting mixed materials into a (high temperature, high pressure) pressure molding machine 19, therefrom the (high temperature, high pressure) pressure molding machine 19 thermally press molds the mixed materials into a shape, thereby molding an environment protection inner lining (sleeve) of a prescribed shape 21, 22, wherefrom the environment protection inner lining (sleeve) may be adapted to fit inside a shoe 23 and clothing 24 (refer to FIGS. 4 and 5), achieving effectiveness of recycling agriculture waste thereof, as well as thoroughly resolving problems of air pollution resulting from burning agricultural waste, and adding supplementary value to agricultural products, thus making best use of agriculture waste, while increasing income of farmers. Moreover, after usage of the environment protection inner lining (sleeve), the environment protection inner lining (sleeve) may be recycled and once more made use of. If organic fertilizers are produced, the organic fertilizers may be utilized to re-manufacture other commodities. If discarded, the environment protection inner lining (sleeve) will autodecompose, effectively eliminating secondary pollution, and thereby achieving objective of environment conservation.

### ADVANTAGES OF THE PRESENT INVENTION

1, Unnecessary to fell trees, thereby averting destruction of forests and effecting damage to natural environment ecosystem.

2, Avoids causing pollution to water sources.

3, Contributes to effectiveness of environment conservation.

4, Resolves problem of air pollution caused by combustion of agriculture waste.

5, of beneficial value to agriculture.

6, High practicality.

7, Industrial competitiveness.

In conclusion, the present invention has assuredly accomplished desired effectiveness of advancement, and advanced creativeness of technical art. The present invention, in addition to being of benefit to industry, also has creativeness not found in prior art of other persons. Furthermore, the present invention has not been made public before patent application presented herein, even though already demonstrating effectiveness. Advancement of the present invention evidently complies with conditions for an invention patent; accordingly a patent application is submitted herein.

It is of course to be understood that the embodiments described herein is merely illustrative of the principles of the invention and that a wide variety of modifications thereto may be effected by persons skilled in the art without departing from the spirit and scope of the invention as set forth in the following claims.

1. An environment protection inner lining (sleeve) employing a multi-stage processing method, comprising steps of:
a), employ a shredder (slicer) to first shred fibrous raw materials from agricultural waste products, such as rice hulls, wheat hulls, sorghum hulls, peanut shells, bean pods, coconut hulls, rice stems, wheat stems, corn stems, sorghum stems, bean stems, cotton stems, timber, bamboo, etc., thereafter use a drier to dry the fibrous raw materials, subsequently, use a pulverizer to pulverize the fibrous raw materials, after pulverizing, main raw material is acquired in powder form, finally employ a vacuum packaging machine to pack the powder, thereby acquiring a finished product of the main raw material;
b), next, simultaneously place plant starch and water into a rabbling barrel and rabble, while at the same time heat and rabble the plant starch and water with a heater rabbling reactor, forming a thick form of paste thereof, subsequently, add an additive of liquid gelatin, thereby acquiring a finished product of the additive;
c), finally add the main raw material (approximately 70% by weight) and starch (approximately 17% by weight) to a rabbler, simultaneously spray the additive (approximately 13% by weight) into the rabbler with an automatic spray machine and synchronously stir, after the main raw material, the additive and the starch have been thoroughly stirred, store in a stand-alone storage barrel, and employ an automatic feed gauging system to feed the mixed material into a (high temperature, high pressure) pressure molding machine, therefrom the (high temperature, high pressure) pressure molding machine thermally press molds the mixed material into a shape, thereby molding an environment protection inner lining (sleeve) of a prescribed shape, thereafter, extract the environment protection inner lining (sleeve) by means of a manipulator extractor, thus achieving effectiveness of a rapid shape-forming processing method.
